(19) United States
(12) Patent Application Publication
(10) Pub. No.: US 2025/0249840 A1
(43) Pub. Date: Aug. 7, 2025

(54) VEHICLE HEADLINER AND APPARATUS OF MANUFACTURING THE SAME

(71) Applicant: DAEHAN SOLUTION CO., LTD, Incheon (KR)

(72) Inventors: CHOONG HO KWON, SEOUL (KR); YUNGEUN GWAK, INCHEON (KR)

(21) Appl. No.: 18/675,678

(22) Filed: May 28, 2024

(30) Foreign Application Priority Data
Feb. 2, 2024 (KR) 10-2024-0016487

(51) Int. Cl. B60R 13/02; B29C 67/20; B29C 67/24; B29K 75/00; B29K 105/04; B29K 105/08; B29K 709/08; B29L 31/30

(52) U.S. Cl. CPC B60R 13/0225; B29C 67/20; B29C 67/24; B29K 2075/00; B29K 2105/04; B29K 2105/0854; B29K 2709/08; B29K 2995/0063; B29L 2031/3011

(57) ABSTRACT

The present invention relates to a vehicle headliner and an apparatus for manufacturing the same, in which a substrate is pre-molded into a shape of the headliner, and then rigid or semi-rigid polyurethane is partially continuously foam-molded on the entire surface of a molded substrate to match the shape and thickness of the headliner, thereby it is possible to simplify the manufacturing process while reducing unintended buzz, squeak and rattle (BSR) and weight. In this case, a mold used for foam-molding the polyurethane is divided into several split molds and then the split molds are connected in the form of a single chain, and the polyurethane is partially foam-molded as the split molds rotate so that the rigid polyurethane is partially and continuously foam-molded on the surface of the substrate.

### CROSS-REFERENCE TO RELATED APPLICATION

This application claims priority to and the benefit of Korean Patent Application No. KR 10-2024-0016487, filed on Feb. 2, 2024, the disclosure of which is incorporated herein by reference in its entirety.

### BACKGROUND

### 1. Field of the Invention

The present invention relates to a vehicle headliner and an apparatus for manufacturing the same, and more particularly, to a vehicle headliner manufactured by foam-molding rigid or semi-rigid polyurethane on a portion of a surface of a substrate pre-molded into a shape of a headliner through a foam molding machine consisting of split molds that rotate in an endless track manner to match the shape and thickness of the headliner having a tolerance between the headliner and a roof panel when the headliner is mounted on the roof panel so that the headliner with the desired rigidity can be manufactured simply and easily compared to the existing method of manufacturing and bonding several layers into one part. In addition, a non-woven fabric is attached to a polyurethane surface so that structural rigidity can be reinforced and durability can also be improved by not easily tearing.

### 2. Discussion of Related Art

In general, a headliner is mounted inside a vehicle to face a roof panel. The headliner is one of the multi-purpose interior materials that not only enhance the interior design and appearance and effectively reduce noise and vibrations, but also regulate the interior temperature and heat to maintain a constant temperature and protect a driver and passengers in the case of a vehicle accident.

Such headliners are manufactured through various manufacturing apparatuses, such as Patent Documents 1 to 3.

### (Patent Document 1) Korean Registered Patent Publication No. 10-2385361

Patent Document 1 discloses a device for manufacturing an interior ceiling material for a vehicle, and the device includes: a surface material supply device including a surface material pallet X-Y alignment device that primarily aligns pallets on which surface materials are stacked along X-Y axes, a surface material fine X-Y alignment device disposed at an interval below the surface material pallet X-Y alignment device in a Y-axis direction that secondarily finely aligns the surface materials so that the surface materials are disposed in place, and a surface material loading device installed to reciprocate between the surface material pallet X-Y alignment device and the surface material fine X-Y alignment device along a surface material Y-axis supply rail installed above the surface material pallet X-Y alignment device and the surface material fine X-Y alignment device; a substrate material supply device including a substrate material pallet X-Y alignment device disposed at an interval to the left of the surface material pallet X-Y alignment device in an X-axis direction and primarily aligns the pallets on which the substrate material is stacked along the X-Y axes, a substrate material fine X-Y alignment device disposed at an interval below the substrate material pallet X-Y alignment device in the Y-axis direction that secondary finely aligns the substrate material so that the substrate material is disposed in place, and a substrate material loading device installed to reciprocate between the substrate material pallet X-Y alignment device and the substrate material fine X-Y alignment device along a substrate material Y-axis supply rail installed above the substrate material pallet X-Y alignment device and the substrate material fine X-Y alignment device; an oven that is disposed at an interval to the left of the substrate material supply device and preheats the surface materials and the substrate material to allow the surface materials and the substrate material to be compressed and the substrate material to be foamed; a positive pressure press disposed at an interval to the left of the oven and consisting of an upper mold and a lower mold to compress the substrate material and the surface materials supplied through the oven in upward and downward directions; and an X-axis supply rail part including a pair of substrate material X-axis supply rails integrally extending from the substrate material fine X-Y alignment device to the positive pressure press and installed from the substrate material fine X-Y alignment device to the positive pressure press, a pair of surface material X-axis supply rails integrally extending from the substrate material fine X-Y alignment device to the positive pressure press and installed from the surface material fine X-Y alignment device to the positive pressure press, a rail driving part composed of a substrate material X-axis supply rail driving part that is connected to the substrate material X-axis supply rail and moves along the substrate material X-axis supply rail, and drives the substrate material supply part, a surface material supply part connected to the surface material X-axis supply rail and moving along the surface material X-axis supply rail, and a surface material X-axis supply rail driving part driving the surface material supply part.

### (Patent Document 2) Korean Registered Patent Publication No. 20-0272799

Patent Document 2 relates to an assembly device for a vehicle sun roof headliner, and a steel bracket is formed to be connected to the upper surface of the headliner through a rivet, a bent ridge with a through hole is drilled in the center thereof, bending clips standing on the outer left and right sides of the bent ridge are formed, a stopper is formed between the bending clips, and a hook bracket for connection to the steel bracket includes a concave portion formed below the hook piece with one side curved, guide grooves bent slightly downward from the outer side of the concave portion and formed on the left and right sides of the other end side, and a locking groove formed in the center of the guide groove, wherein the end of the hook bracket is pushed into the through hole through a bottom space of the bent ridge of the steel bracket and further pushed until the locking groove is caught by the stopper while the bending clips are inserted into the guide grooves, and then the bending clips are bent to the upper surface of the hook bracket to assemble the hook bracket to the steel bracket, and in this state, when a sunroof body panel is mounted, the lower surface of the hook piece is pushed into the roof panel to prevent the headliner from sagging and to be assembled together with other sub-parts when the other sub-parts are assembled. Accordingly, it is possible to obtain the effects of improving quality and simplifying assembly as compared with bonding the conventional dual lock with a double-sided tape which is weak to a temperature change.

### (Patent Document 3) Korean Registered Patent Publication No. 10-1828416

Patent Document 3 relates to an apparatus for trimming vehicle headlining materials that is capable of hybrid processing (trimming) headlining materials of various types of vehicles. The apparatus for trimming vehicle headlining materials according to an embodiment of the disclosed invention includes: a worktable provided with an upper frame; first and second cutters installed at both side edges in a width direction of an upper surface of the worktable; first and second edge supporters installed on the upper surface of the worktable and positioned in front of the first and second cutters, respectively; first and second center platforms installed parallel to each other in a width direction at the center of the worktable; first and a second edge press bars installed on the upper frame and positioned above the first and second edge supporters, respectively; and first and second center press bars installed on the upper frame and positioned above the first and second center platforms, respectively.

### Related Art Documents

### Patent Documents

### (Patent Document 1) Korean Registered Patent Publication No. 10-2385361 (May 17, 2022)

### (Patent Document 2) Korean Registered U.M. Publication No. 20-0272799 (Apr. 8, 2002)

### (Patent Document 3) Korean Registered Patent Publication No. 10-1828416 (Feb. 6, 2018)

### SUMMARY OF THE INVENTION

The present invention is directed to providing a vehicle headliner and an apparatus for manufacturing the same, in which a substrate is preformed in a shape of the headliner, and then rigid or semi-rigid polyurethane is partially and continuously foam-molded on the entire surface of the molded substrate to match the shape and thickness having a tolerance between the headliner and the roof panel when the headliner is mounted on the roof panel, which are formed integrally, and thus the manufacturing process can simplified while unintended buzz, squeak and rattle (BSR) and weight can be reduced.

The present invention is also to providing a vehicle headliner and an apparatus for manufacturing the same, in which a mold used for foam molding polyurethane is divided into several split molds and then the split molds are connected in the form of a single chain, and the polyurethane is partially foam-molded as the split molds rotate so that rigid polyurethane can be partially and continuously foam-molded on a surface of the substrate.

The present invention is also to providing a vehicle headliner and an apparatus for manufacturing the same, in which a rigid or semi-rigid polyurethane having a density of 10 to 40 kg/m³ is used as polyurethane, and in some cases, a glass fiber having a surface density of 20 to 200 g/m² is used so that BSR can be improved while the structural rigidity required by the headliner can be reinforced to some extent.

According to an aspect of the present invention, there is provided an apparatus for manufacturing a vehicle headliner, including a foam molding machine (100) that manufactures the headliner (10) by partially and repeatedly foam molding a rigid or semi-rigid polyurethane (20) having a density of 10 to 40 kg/m³ on an surface of a molded article (10′) facing a roof panel to match the shape and thickness having a tolerance between the headliner and the roof panel when the headliner is mounted on the roof panel, in which the molded article (10′) is formed in a shape of the headliner by heat-molding a substrate (11) including a surface material (11′) and a glass fiber mat (11″) adhered by an adhesive (12), wherein the foam molding machine (100) includes: an endless track type conveyor (110) that continuously supplies the molded article (10′); two sprockets (120′) mounted on the conveyor (110) or around the conveyor (110) to face the conveyor (110), and a chain (120″) mounted on the two sprockets (120′) to rotate endlessly; two or more sets of foam molds (130) installed on the molded article (10′) to face the molded article (10′), wherein the foam molds (130) are divided into several split molds (130a to 130g) in a direction crossing a movement direction of the molded article (10′) and mounted to rotate endlessly on the chain (120″); a pressing member (140) installed in a space surrounded by the chain (120″) to support the split molds (130a to 130g) located at an upper portion thereof and to press the split molds (130a to 130g) located thereunder; and a foamer (150) that foams the polyurethane before or after the foam mold (130) faces and is engaged with the molded article (10′).

In the molded article (10′), components may be pre-installed on a surface of the headliner facing the roof panel.

Each of the split molds (130a to 130g) may be provided with a roller (131) facing the pressing member (140).

The foam molding machine (100) may include a device for attaching a non-woven fabric (30) to a polyurethane surface of the headliner (10) obtained by foam molding polyurethane through the foam molding machine (100).

A glass fiber having a surface density of 20 to 200 g/m² may be added to the polyurethane (20).

An adhesive (21) may be applied or an adhesive film may be provided between a surface of the glass fiber mat (11″) and the rigid or semi-rigid polyurethane (20).

According to another aspect of the present invention, there is provided a vehicle headliner manufactured by the apparatus for manufacturing the above-described vehicle headliner.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a side view showing a vehicle equipped with a headliner according to the present invention;

FIG. 2 is a perspective view exemplary showing a substrate used in manufacturing a vehicle headliner according to the present invention;

FIG. 3 is a perspective view showing a molded article formed in a headliner shape by heat-molding the substrate of FIG. 2 according to the present invention;

FIG. 4 is an image showing an example in which a substrate according to the present invention is heat-molded into a headliner shape;

FIG. 5 is a configuration diagram showing a foam molding machine for foam-molding polyurethane on a surface of a molded article according to the present invention;

FIG. 6 is a perspective view showing a portion of the configuration of the foam molding machine according to the present invention;

FIG. 7 is an image showing a headliner manufactured with the foam molding machine according to the present invention;

FIG. 8 is a cross-sectional view showing an example in which a non-woven fabric is added on foam-molded polyurethane according to the present invention; and

FIG. 9 is a cross-sectional view showing an example in which an adhesive is applied or an adhesive film is added between a glass fiber mat surface and rigid or semi-rigid polyurethane according to the present invention.

### DETAILED DESCRIPTION OF EXEMPLARY EMBODIMENTS

Hereinafter, preferred embodiments of the present invention will be described in detail with reference to the accompanying drawings. Prior to this, terms or words used in this specification and claims should not be construed as limited to their ordinary or dictionary meanings and should be interpreted as meanings and concepts consistent with the technical idea of this invention, based on the principle that the inventor may appropriately define the concept of terms to explain his or her invention in the best way.

Accordingly, it is to be understood that the embodiments described herein and the configurations illustrated in the drawings are only some of the most preferred embodiments of the present invention and are not intended to represent the entire technical idea of the present invention, and that there may be various equivalents and variations that may be substituted therefor at the time of filing this application,

### Headliner Manufacturing Apparatus

As shown in FIGS. 1 to 9, an apparatus for manufacturing a vehicle headliner 10 includes a foam molding machine 100 for partially and repeatedly foam-molding a rigid or semi-rigid polyurethane 20 having a density of 10 to 40 kg/m³ over the entire surface of a molded article 10′ formed in the shape of the headliner 10 by heat-molding a substrate 11 to match the shape and thickness of the headliner 10 having a tolerance between the headliner 10 and a roof panel when the headliner is mounted on the roof panel.

In particular, the foam molding machine 100 is configured to divide a mold for forming the headliner 10 into several split molds 130a to 130g to be connected in a chain form, and as the polyurethane 20 is foamed on the surface of the molded article 10′, the split molds 130a to 130g are sequentially engaged to face the molded article 10′, or the split molds are engaged, and then the polyurethane 20 is foamed. Accordingly, it is possible to manufacture a headliner 10 foam-molded on the molded article 10′ to match a thickness of the space and shape between the rigid or rigid polyurethane 20 and the roof panel when the headliner is mounted on the roof panel.

In addition, the foam molding machine 100 may be configured so that a non-woven fabric 30 is attached to a surface of the polyurethane 20 of the headliner 10. Accordingly, not only does it reinforce the rigidity of the headliner 10, but it may also improve durability by not easily tearing, and it may also improve its performance against buzz, squeak and rattle (BSR), which is a noise that is unintentionally generated when driving.

Further, the polyurethane 20 to which a glass fiber having a surface density of 20 to 200 g/m² is added may be used, thereby further improving noise performance as well as the rigidity of the headliner 10.

Meanwhile, an adhesive 21 or an adhesive film is applied or provided between the surface of a glass fiber mat 11″ and the polyurethane 20 so that the substrate 11 and the polyurethane 20 may be firmly attached and integrated.

Hereinafter, this configuration will be described in more detail with reference to the attached drawings.

### A. Substrate

As shown in FIGS. 1 to 3, the substrate 11 is a member that constitutes a surface layer of the headliner 10, and in particular, the substrate 11 is a member for constituting a molded article 10′ that is molded into the entire shape of the headliner 10 after the layer is formed to have a predetermined rigidity.

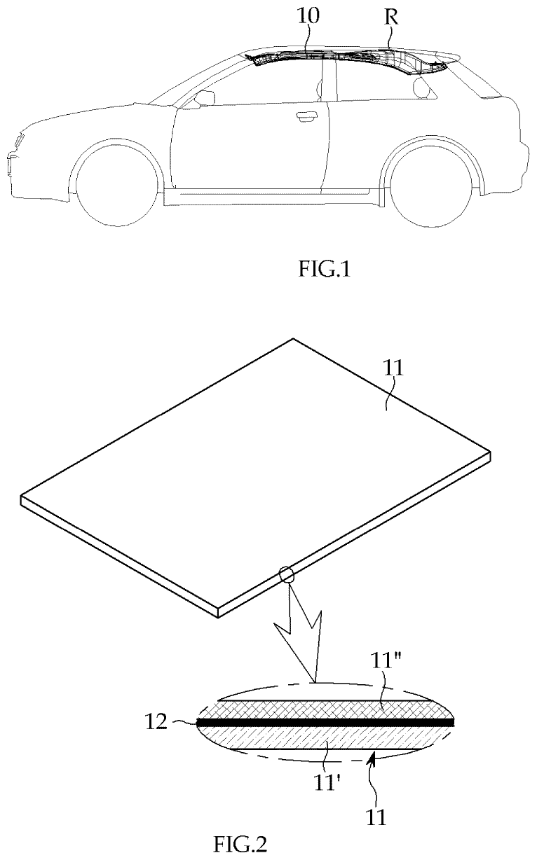

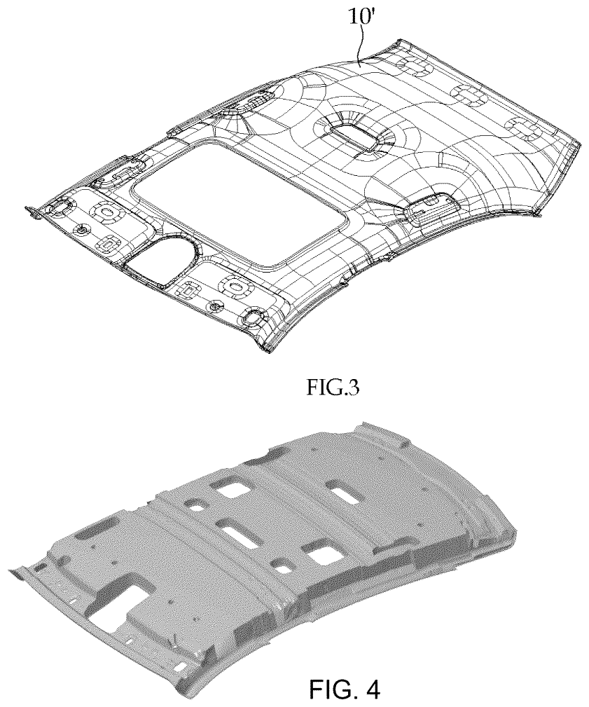

This substrate 11 includes a surface material 11′ and a glass fiber mat 11″, as shown in FIGS. 2 and 3.

### 1. Surface Material

As shown in FIG. 2, the surface material 11′ is exposed to the interior of the vehicle and made of cloth, leather, or a material that feels the same or similar to the cloth or leather. Of course, the surface material 11′ may be used by covering the surface of the substrate 11 with another material without being exposed to the interior of the vehicle. This surface material 11′ is molded integrally with the above-described glass fiber mat 11″ through an adhesive 12 such as a hot melt adhesive.

### 2. Glass Fiber Mat

The glass fiber mat 11″ is a mat that is integrally attached to the surface material 11′, as shown in FIG. 2. In this case, the glass fiber mat 11″ reinforces the rigidity so that the overall shape can be maintained when the substrate 11 is molded into the shape of the headliner 10.

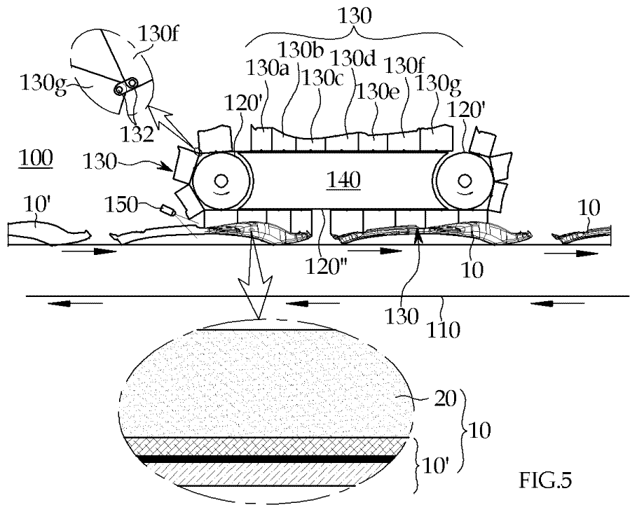

The substrate 11 thus formed is introduced into a thermoforming mold made using conventional technology and heated to a predetermined temperature while applying pressure to form a molded article 10′ corresponding to the surface of the headliner 10, as shown in FIGS. 3 and 4.

In a preferred embodiment of the present invention, the headliner may be manufactured by foaming polyurethane in the form of a covering for the headliner 10 as described hereinafter, but it is desirable to pre-install components on the surface facing the roof panel in the molded article 10′ so that the components may be buried by the polyurethane. Here, the components refer to those mounted on the surface of the headliner facing the roof panel, such as wiring mounted on the surface of the headliner, various brackets for mounting lights, etc.

### B. Foam Molding Machine

As shown in FIGS. 5 to 7, the foam molding machine 100 is a device for molding the headliner 10 by foam-molding rigid or semi-rigid polyurethane 20 on the surface of the molded article 10′ facing the roof panel to match the shape and thickness having a tolerance between the headliner 10 and the roof panel when the headliner is mounted on the roof panel.

In this case, the polyurethane 20 is foam-molded using a rigid or semi-rigid polyurethane having a density of 10 to 40 kg/m³ so that the rigidity of the headliner 10 can be sufficiently reinforced and buzz, squeak, and rattle (BSR), which is an unintended noise when the vehicle is driven, can be prevented to provide a comfortable indoor environment.

In addition, in a preferred embodiment of the present invention, a glass fiber having a surface density of 20 to 200 g/m² may be added to the polyurethane 20. This is for obtaining the required rigidity and noise performance of the headliner 10 by adding and using glass fibers to the polyurethane 20 when sufficient rigidity and noise performance cannot be obtained even if the rigid or semi-rigid polyurethane 20 is foam-molded on the substrate 11.

Meanwhile, the foam molding machine 100 includes a conveyor 110, sprockets 120′ and a chain 120″, a foam mold 130, a pressing member 140, and a foamer 150, as shown in FIGS. 5 to 7.

### 1. Conveyor

The conveyor 110 is for continuously supplying the molded article 10′, as shown in FIG. 5. In this case, the conveyor 110 is connected at both ends in an endless track manner, and several molded articles 10′ are sequentially placed thereon and continuously moved so that the polyurethane 20 is foam-molded through the foam mold 130 and the foamer 150, which will be described below.

This conveyor 110 may be manufactured using conventional technology, and it is preferable to pre-mold the molded article 10′ in the shape of the molded article 10′ on a contact surface so that the molded article 10′ is not deformed or damaged during foam molding.

### 2. Sprocket and Chain

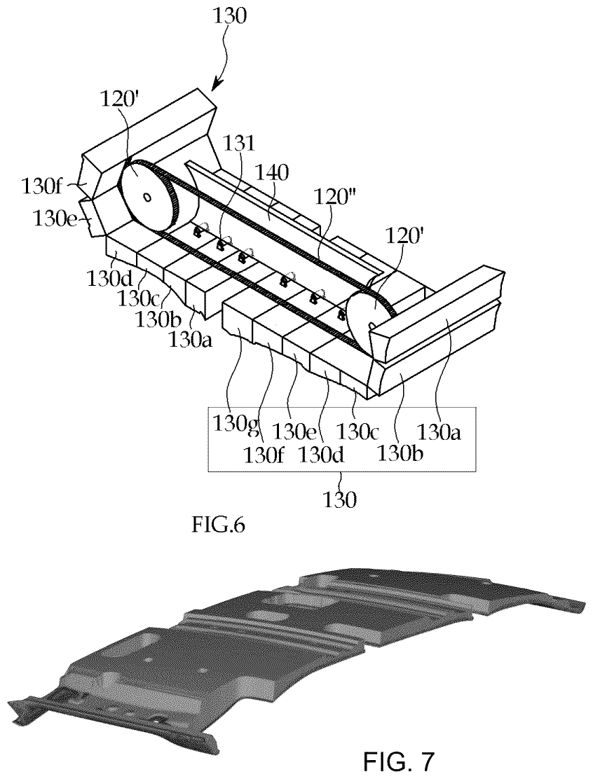

The sprocket 120′ is mounted on or around the side surface of the conveyor 110 so as to be located above the conveyor 110, as shown in FIGS. 5 and 6. In this case, two sprockets 120′ are mounted parallel to each other, and a chain 120″ is connected to these two sprockets 120′ in a closed loop form so that during the transfer of the split molds 130a to 130g, which will be described below, the polyurethane 20 may be foamed into each of the split molds 130a to 130g, which are sequentially engaged to face the molded article 10′.

### 3. Foam Mold

The foam mold 130 is a mold, which is engaged with the molded article 10′, for molding the headliner 10 by foaming the polyurethane 20, and in particular, the foam mold 130 is formed by dividing the mold into several foam molds 130a to 130g in the width direction of the molded article 10′ moving along the conveyor 110, as shown in FIGS. 5 and 6.

In this case, as shown in FIG. 5, each of the foam molds 130a to 130g may stably return without interference as two adjacent molds are connected by pins 132 and the chain 120″ rotates in a closed curve shape, and may be engaged in turn to face the molded article 10′ placed on the conveyor 110.

In a preferred embodiment of the present invention, it is preferable that two or more sets of foam molds 130a to 130g are provided. This is to ensure that while polyurethane is being foam-molded in one foam mold, the polyurethane in another foam mold that has already been foam-molded may be cured. FIG. 5 shows an exemplary configuration of three sets of foam molds 130a to 130g.

### 4. Pressing Member

The pressing member 140 is mounted in a space surrounded by the chain 120″, as shown in FIGS. 5 and 6. In this case, the pressing member 140 supports the split molds 130a to 130g located at the upper portion of the chain 120″ so that the split molds do not sag downward, and presses the split molds 130a to 130g located at the lower portion of the chain 120″ so that the split molds are well engaged with the molded article 10′.

In this case, each of the split molds 130a to 130g in contact with the pressing member 140 is preferably configured to minimize the friction generated between the split mold and the pressing member 140 when driven by the chain 120″ with a roller 131 as shown in FIG. 6. Of course, it is preferable that the roller 131 is configured to mount a guide on the pressing member 140 and perform a rolling motion under the guidance of the guide.

### 5. Foamer

As shown in FIG. 5, the foamer 150 is mounted on or around the conveyor 110 so as to be located at a portion where the molded article 10′ is introduced. In this case, the foamer 150 is a device for foam-molding the rigid or semi-rigid polyurethane 20 on the surface of the molded article 10′. In addition, the foamer 150 may be configured to foam the polyurethane 20 in a cavity formed in a engaged split mold while the split molds 130a to 130g are engaged with the molded article 10′ one at a time, or each of the split molds 130a to 130g may be configured to be engaged in sequence after the polyurethane 20 is foamed by the foamer 150.

As described above, using the vehicle headliner manufacturing apparatus according to the present invention, as shown in FIGS. 5 and 7, the headliner 10 is molded by foaming the polyurethane 20, which appears blue, onto the surface of the molded article, which appears green, to complete the molding of the headliner 10. In this case, the polyurethane 20 is manufactured to fill all the complex shapes and gaps between the headliner 10 and the roof panel, and it is formed to have a predetermined tolerance between the roof panel and the polyurethane 20 so that the polyurethane 20 is not in contact with a surface of the roof panel surface.

Meanwhile, the headliner manufacturing apparatus thus constructed may also be configured with an attachment device for adding a non-woven fabric 30 to a surface of the polyurethane 20 thus manufactured, as shown in FIG. 8.

### C. Non-Woven Fabric Attachment Device

The non-woven fabric attachment device is a device for attaching the non-woven fabric 30 to the surface of the rigid or semi-rigid polyurethane 20 on the surface of the molded article 10′, as shown in FIG. 8. In this case, the non-woven fabric 30 supports the headliner 10a so that it does not tear easily, does not deform and retains its shape. This non-woven fabric 30 may be attached using an adhesive such as a hot melt adhesive or may be integrally attached after the polyurethane is foam-molded.

The present invention, which is described above, not only makes it easy and convenient to produce a headliner through a simple process for foam-molding rigid or semi-rigid polyurethane using foam molds connected by a chain on a substrate formed in the shape of a headliner, but also makes it possible to supplement sufficient noise performance and rigidity by foam-molding the polyurethane to match the shape and thickness of the headliner having a tolerance between the headliner and the roof panel.

### Headliner

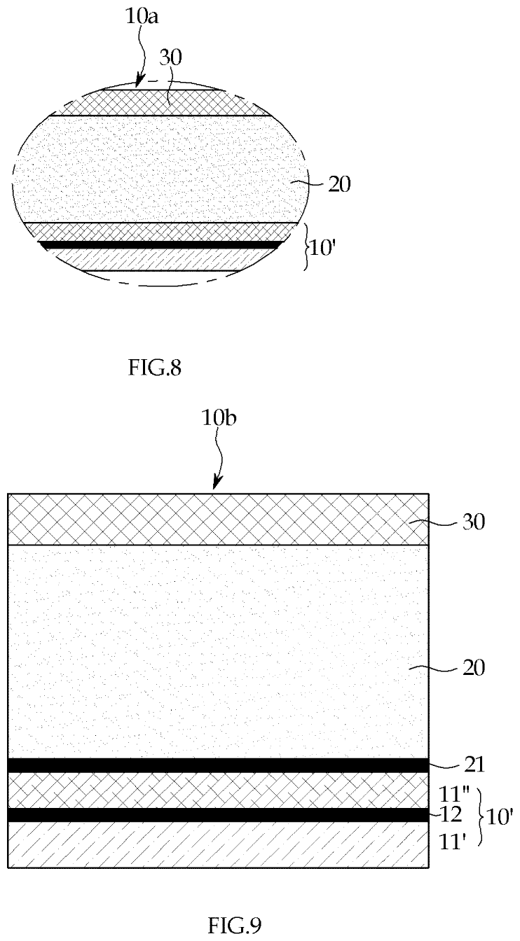

The present invention may include a vehicle headliner manufactured by the apparatus for manufacturing the above-describe vehicle headliner. In addition, the present invention includes a headliner 10b in which the molded article 10′ and the polyurethane 20 are firmly attached by applying an adhesive 21 or inserting an adhesive film between the glass fiber mat 11″ and the rigid or semi-rigid polyurethane 20, as shown in FIG. 9.

A vehicle headliner and an apparatus for manufacturing the same according to the present invention have the following effects.
(1) Since polyurethane is partially and repeatedly foam-molded on the entire surface of a pre-molded substrate in the shape of a headliner to match the shape and thickness of the headliner and then the headliner is molded by attaching a non-woven fabric thereon, a layer structure constituting the headliner can be simplified and the headliner can be simply manufactured.
(2) In this case, since a rigid or semi-rigid polyurethane having a density of 10 to 40 kg/m³ is used, the polyurethane is partially foam-molded on the surface of a substrate to be molded into the desired thickness and shape, and thus the polyurethane, which is cured in a short time, can be stably foam-molded, and buzz, squeal and rattle (BSR), which is an unwanted noise while driving, can be improved.
(3) In addition, as a glass fiber having a surface density of 20 to 200 g/m² is added to the polyurethane and the polyurethane is foam-molded, the structural rigidity of the headliner can be reinforced and noise performance can also be improved.
(4) Further, the polyurethane is foam-molded on the surface of the substrate which is coated with a hot melt adhesive or on which a hot melt film is inserted so that a headliner with further enhanced rigidity can be manufactured by firmly attaching the polyurethane to the substrate.
(5) Meanwhile, since a foam molding thickness of polyurethane can be easily adjusted, it can be conveniently and safely used by simply performing foam molding to match the desired shape and thickness for the desired portion.
(6) In addition, even when the headliner and the roof panel have an inconstant gap therebetween and a complex shape, it can be manufactured to correspond thereto, and thus the desired rigidity and noise performance can be sufficiently obtained.
(7) Finally, components installed on the surface of the headliner facing the roof panel, such as brackets for mounting wiring or lighting devices, opening brackets, etc., are pre-installed and then polyurethane is applied to manufacture the headliner so that the process of installing the components on the headliner can be simplified to increase the productivity, and the components can be more securely attached to improve noise performance.

What is claimed is:

1. An apparatus for manufacturing a vehicle headliner, comprising a foam molding machine (100) that manufactures a headliner (10) by partially and repeatedly foam-molding a rigid or semi-rigid polyurethane (20) having a density of 10 to 40 kg/m³ on an surface of a molded article (10′) facing a roof panel to match a shape and thickness having a tolerance between the headliner and the roof panel when the headliner is mounted on the roof panel, in which the molded article (10′) is formed in a shape of the headliner by heat-molding a substrate (11) including a surface material (11′) and a glass fiber mat (11″) adhered by an adhesive (12),
wherein the foam molding machine (100) includes:
an endless track type conveyor (110) that continuously supplies the molded article (10′);
two sprockets (120′) mounted on the conveyor (110) or around the conveyor (110) to face the conveyor (110), and a chain (120″) mounted on the two sprockets (120′) to rotate endlessly;
two or more sets of foam molds (130) installed on the molded article (10′) to face the molded article (10′), wherein the foam molds (130) are divided into several split molds (130a to 130g) in a direction crossing a movement direction of the molded article (10′) and mounted to rotate endlessly on the chain (120″);
a pressing member (140) installed in a space surrounded by the chain (120″) to support the split molds (130a to 130g) located at an upper portion thereof and press the split molds (130a to 130g) located thereunder; and
a foamer (150) that foams the polyurethane before or after the foam mold (130) faces and is engaged with the molded article (10′).

2. The apparatus of claims 1, wherein, in the molded article (10′), components are pre-installed on a surface of the headliner facing the roof panel.

3. The apparatus of claim 1, wherein each of the split molds (130a to 130g) is providedwith a roller (131) facing the pressing member (140).

4. The apparatus of claim 1, wherein the foam molding machine (100) includes a device for attaching a non-woven fabric (30) to a polyurethane surface of the headliner (10) obtained by foam-molding the polyurethane through the foam molding machine (100).

5. The apparatus of claim 1, wherein a glass fiber having a surface density of 20 to 200 g/m² is added to the polyurethane (20).

6. The apparatus of claim 1, wherein an adhesive (21) is applied or an adhesive film is provided between a surface of the glass fiber mat (11″) and the rigid or semi-rigid polyurethane (20).

7. A vehicle headliner manufactured by the apparatus of claim 1.

8. A vehicle headliner manufactured by the apparatus of claim 2.

9. A vehicle headliner manufactured by the apparatus of claim 3.

10. A vehicle headliner manufactured by the apparatus of claim 4.

11. A vehicle headliner manufactured by the apparatus of claim 5.

12. A vehicle headliner manufactured by the apparatus of claim 6.
